(19) United States
(12) Patent Application Publication
(10) Pub. No.: US 2003/0078715 A1
(43) Pub. Date: Apr. 24, 2003

(54) Arrangement having a damper element, motor vehicle with such an arrangement and method for operating such an arrangement or such a motor vehicle

(76) Inventor: Stephan Zecha, Hosbach (DE)

Correspondence Address: Bruce W. Slayden II, Baker Botts LLP, 910 Louisiana, Houston, TX, 77002-4995, US

(21) Appl. No.: 10/251,088

(22) Filed: Sep. 20, 2002

(30) Foreign Application Priority Data
Sep. 20, 2001 (DE) DE10146399.5

(51) Int. Cl. B60R 21/32

(52) U.S. Cl. 701/45; 180/282; 280/735

(57) ABSTRACT

An arrangement having a damper element (4) and a displacement sensor (5a,5b) which detects the compression travel of said damper element (4) when a force is applied, is connected to the damper element (4) and makes available an output signal for processing in a motor vehicle restraint system is described.

### CROSS REFERENCE TO RELATED APPLICATION

This application claims priority to German application DE 10146399.5 filed Sep. 20, 2001.

### BACKGROUND OF THE INVENTION

When a motor vehicle impacts against a fixed or moving obstacle at a low speed or when there is what is referred to as an off-set collision, that is to say a collision in which the other vehicle or an obstacle does not hit the entire width of the vehicle but rather the collision only takes place on one side, there are to a certain extent considerable difficulties in making a decision about the triggering of a restraint unit, in particular an airbag. Previous solutions provide acceleration sensors in the front part of the vehicle from whose signals it is possible at least to determine an off-set collision.

### SUMMARY OF THE INVENTION

The object of the invention is to specify a solution to this problem which permits the earliest possible detection of the degree of severity of a collision or of an impact so that a prompt decision about the triggering of a restraint unit is possible.

The object is achieved by means of an arrangement having a damper element and a displacement sensor which detects the compression travel of said damper element when a force is applied, is connected to the damper element and makes available an output signal for processing in a motor vehicle restraint system.

Another embodiment is a motor vehicle having a bumper which is connected to the vehicle frame by means of damper elements, and having restraint units and a processing and control unit which controls the actuation and triggering of said restraint units, wherein displacement sensors which are connected to the processing and control unit are arranged on the damper elements.

A method for operating an arrangement having a damper element and a displacement sensor which detects the compression travel of said damper element when a force is applied, comprises the steps of:

acquiring an acceleration value which is a measure of the force acting on the damper element from the output signal, representing a travel, of a displacement sensor.

Another method for operating an arrangement within a motor vehicle having a bumper which is connected to the vehicle frame by means of damper elements, and having restraint units and a processing and control unit which controls the actuation and triggering of said restraint units, wherein displacement sensors which are connected to the processing and control unit are arranged on the damper elements, comprises the steps of:

acquiring an acceleration value, which is a measure of the force acting on the damper element and which can be used to activate the restraint system or restraint units early, from the output signal, representing a travel, of a displacement sensor.

Advantageous developments of the invention are given in the dependent claims.

In motor vehicles, the bumper is usually connected to the frame of the vehicle by means of damper elements. These damper elements are usually dimensioned in such a way that when an impact occurs at a low speed they absorb the entire energy of the collision elastically or else non-elastically under deformation so that the rest of the bodywork of the vehicle or the frame of the vehicle is not damaged.

Taking such a vehicle design as a basis, a described damper element according to the invention is connected to a displacement sensor which makes available an output signal for processing in a motor vehicle restraint system.

In this context, the displacement sensor may detect, in a known way, the deformation travel of the damping element by means of an inductive, capacitive, optical method or some other method. The impact speed, the accelerations which occur at that time and, derived therefrom, the forces which occur can then be concluded, by means of suitable algorithms, from the signal which is supplied by a displacement sensor and is proportional to the travel, in a processing and control unit.

The invention can particularly advantageously be implemented in conjunction with elastic or reversible damping elements as an impact at low speed does not lead to the destruction of a damping element here, and the additional expenditure on the displacement sensors thus only has to be incurred once.

Owing to the inventive embodiment of an arrangement with a damping element and its interaction with a restraint system in a motor vehicle, it is possible to implement early collision detection, in particular if the information relating to the speed and the mass of the vehicle is fed as further parameters to the processing and control unit.

### BRIEF DESCRIPTION OF THE DRAWINGS

The invention is explained in more detail below by means of an exemplary embodiment and with reference to figures, in which:

FIG. 1 shows the schematic outline of a motor vehicle according to the invention with an arrangement according to the invention, and

FIG. 2 shows a diagram of the sequence of a method according to the invention.

### DETAILED DESCRIPTION OF THE PREFERRED EMBODIMENTS

A first vehicle 1 which is illustrated in a highly schematic form has a vehicle frame 2 to which a bumper 3 is connected via two damping elements 4. The damping elements 4 are embodied in the illustrated exemplary embodiment as reversible damping elements having a piston which can be displaced in a cylinder, as is known, for example, from DE 30 28 448 A1.

Displacement sensors 5a,5b which are composed of a first part 5a which is connected to the cylinder, connected to the vehicle frame 2, of the damping element 4, and of a second part 5b which is connected to the movable piston of the damping element 4 are arranged on the damping elements 4. The displacement sensors 5a,5b are connected via lines 6 to a processing and control unit 7. The processing and control unit 7 is used, inter alia, to actuate restraint units, for example airbags or seatbelt pretensioners, and may be considered to be part of a restraint system.

The displacement sensors 5a,5b can operate according to all known methods. Thus, inductive, capacitive or optical methods are conceivable as well as measuring methods using Hall sensors or acoustic surface wave filters, to give only a few examples.

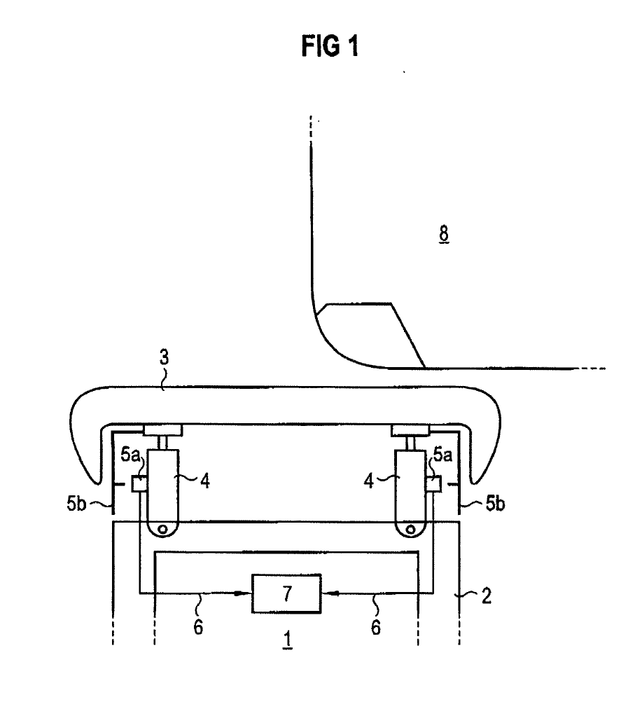

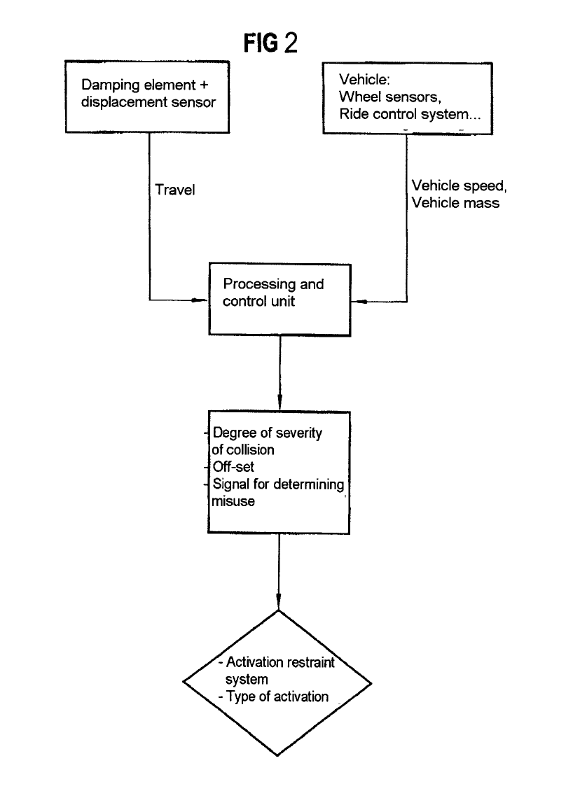

FIG. 2 shows the sequence of the method for acquiring a criterion for the triggering of a restraint system for protecting vehicle occupants from the distance traveled by the bumper 3 when there is an off-set collision (illustrated in FIG. 1) with a second vehicle 8 when the first vehicle 1 is at a low speed.

The arrangement according to the invention composed of a damping element 4 and a displacement sensor 5a,5b supplies a signal which is proportional to the distance traveled by the bumper 3 to the processing and control unit 7. The processing and control unit 7 also receives information relating to the vehicle speed and the vehicle mass from other vehicle units (not illustrated) such as, for example, wheel sensors or a ride control system (leveling or height control system). Data relating to the force and the penetration speed acting during the collision can be calculated from this information by the processing and control unit 7. From said data, said processing and control unit 7 acquires information about the degree of severity of the collision, information about the collision off-set from the different signals of the two arrangements 4,5a,5b as well as information for determining misuse. All this information can then be used, according to known rules, for deciding about the actuation of restraint devices of a restraint system and the method of actuation.

Although the illustration of FIG. 1 illustrates only two arrangements 4,5a,5b according to the invention, the invention is not restricted to this number. It is also possible at any time to provide more than two or even only one such arrangement 4,5a,5b.

Patent claims

1. An arrangement having a damper element and a displacement sensor which detects the compression travel of said damper element when a force is applied, is connected to the damper element and makes available an output signal for processing in a motor vehicle restraint system.

2. The arrangement as claimed in claim 1, wherein the damper element is of reversible design.

3. The arrangement as claimed in claim 1, wherein the displacement sensor is a sensor from the group of inductive sensors, capacitive sensors, Hall sensors, surface acoustic wave sensors and optical sensors.

4. The arrangement as claimed in claim 1, wherein the damper element is coupled with a bumper.

5. A motor vehicle having a bumper which is connected to the vehicle frame by means of damper elements, and having restraint units and a processing and control unit which controls the actuation and triggering of said restraint units, wherein displacement sensors which are connected to the processing and control unit are arranged on the damper elements.

6. The motor vehicle as claimed in claim 5, wherein the damper elements are of reversible design.

7. The motor vehicle as claimed in claim 5, wherein the displacement sensor is a sensor from the group of inductive sensors, capacitive sensors, Hall sensors, surface acoustic wave sensors and optical sensors.

8. The motor vehicle as claimed in claim 5, wherein two damper elements each comprising an associated displacement sensor are coupled with the bumper.

9. The motor vehicle as claimed in claim 5, comprising further sensors for providing information about the vehicle speed and the vehicle mass.

10. The motor vehicle as claimed in claim 9, wherein the further sensors are wheel sensors or a ride control system.

11. A method for operating an arrangement having a damper element and a displacement sensor which detects the compression travel of said damper element when a force is applied, comprising the steps of:
acquiring an acceleration value which is a measure of the force acting on the damper element from the output signal, representing a travel, of a displacement sensor.

12. Method as claimed in claim 11, further acquiring information about the travel speed for generating information about the degree of severity of a collision.

13. A method for operating an arrangement within a motor vehicle having a bumper which is connected to the vehicle frame by means of damper elements, and having restraint units and a processing and control unit which controls the actuation and triggering of said restraint units, wherein displacement sensors which are connected to the processing and control unit are arranged on the damper elements, comprising the steps of:
acquiring an acceleration value, which is a measure of the force acting on the damper element and which can be used to activate the restraint system or restraint units early, from the output signal, representing a travel, of a displacement sensor.

14. Method as claimed in claim 13, further acquiring information about the vehicle speed and the vehicle mass.

15. Method as claimed in claim 14, wherein the acquired information is used to calculate data relating to the force acting during a collision.

16. Method as claimed in claim 14, wherein the acquired information is used to calculate data about the degree of severity of a collision.

17. Method as claimed in claim 13, wherein the arrangement comprises two sensors and the differential information from the two sensors is used to calculate data about a collision off-set.
